(19) United States
(12) Patent Application Publication
(10) Pub. No.: US 2018/0166268 A1
(43) Pub. Date: Jun. 14, 2018

(54) IONIZATION AND ION INTRODUCTION DEVICE FOR MASS SPECTROMETER

(71) Applicant: SHIMADZU CORPORATION, Kyoto-shi, Kyoto (JP)

(72) Inventors: Rui WANG, SHANGHAI (CN); Jiaqi SHEN, SHANGHAI (CN); Qiao JIN, SHANGHAI (CN); Wenjian SUN, SHANGHAI (CN)

(21) Appl. No.: 15/580,230

(22) PCT Filed: Jul. 21, 2016
(86) PCT No.: PCT/IB2016/054330

§ 371 Date: Dec. 6, 2017

(30) Foreign Application Priority Data
Jul. 21, 2015 (CN) 201510430131.8

(51) Int. Cl. H01J 49/10; H01J 49/04; H01J 49/06; H01J 49/24

(52) U.S. Cl. CPC H01J 49/10; H01J 49/24; H01J 49/062; H01J 49/0404

(57) ABSTRACT

The disclosure relates to an ionization and ion introduction device for a mass spectrometer. The device includes an ionization source chamber at a pressure below atmospheric pressure; at least one ionization source, which is arranged in the ionization source chamber; at least one ion focusing guide chamber, which is arranged to guide ions into a mass analysis device chamber connected therewith; at least one transfer chamber at pressure below atmospheric pressure, which is located between the ionization source chamber and the ion focusing guide chamber, comprising an inlet interconnected to the ionization source chamber and an outlet interconnected to the ion focusing guide chamber, wherein the air pressure of the transfer chamber is lower than that of the ionization source chamber but higher than that of the ion focusing guide chamber.

### FIELD OF THE INVENTION

The present invention relates to the technical field of mass analysis, and more specifically to an ionization and ion introduction device for a mass spectrometer.

### BACKGROUND OF THE INVENTION

Mass spectrometer, as an instrument to measure the molecular mass of analyte, is often employed for the detection of complex samples, trace samples, large molecules of biological samples and the like due to features such as high sensitivity and good qualitative and quantitative function. In the mass spectrometer there is one common ionization source that generally generates ions in an atmospheric pressure environment, for example, atmospheric pressure electrospray ionization source. However, such ionization source working at atmospheric pressure has a problem that ions generated in the atmospheric pressure environment are transferred into the mass spectrometer in an extremely low proportion, usually only 1% or even lower, which greatly reduces the detection sensitivity and detection efficiency of the mass spectrometer. Thus, how to improve the transfer efficiency of ions entering a mass spectrometer is a very important problem.

Generally, people enlarges the diameter of the vacuum system interface of the mass spectrometer interconnected to the atmospheric pressure ionization source, thereby directly increasing the total number of ions entering the vacuum system of the mass spectrometer. However, this method also greatly increases the burden of the vacuum system of the mass spectrometer and increases the load of a vacuum pump. There is one other method in which the number of the vacuum system interfaces of the mass spectrometer is increased, so as to enlarge the diameter of the vacuum system interface interconnected to the atmospheric pressure ionization source and simultaneously reduce the load of the corresponding pump of the vacuum system.

For example, U.S. Pat. No. 8,642,946 provides a vacuum interface device for a mass spectrometer, which includes multiple capillaries used for forming multi-stage vacuum interfaces, so as to improve the transfer efficiency of ions without increasing the burden of the final-stage vacuum pump. However, this device is merely to improve the transfer efficiency of ions entering the vacuum interface from the atmospheric pressure interface, and can't reduce neutral solvent impurities or other gas impurities at the same time; moreover, this device is only available for the ion source device working in an atmospheric pressure environment.

U.S. Pat. No. 7,700,913 provides a scheme for separating neutral gas from gas ions, which mainly is applied to the ionization method generating gas ions by surface desorption, for example, Direct Analysis in Real Time (DART) ionization source. Therefore, this scheme is not applicable to the separation between neutral gas and charged droplets.

Similar documents include Chinese patent CN102232238A (U.S. Pat. No. 8,410,431), which focuses ions generated by an ionization source by means of the laminar flow formed by a generated air flow, thereby facilitating more ions to enter the mass spectrometer. This technology mainly is applied to the condition that an atmospheric pressure ionization source is located far away from the inlet of the mass spectrometer and the condition that an analyte has a relatively big detection area. Thus, this technology is suitable for direct-analysis ionization, for example, Desorption Electrospray Ionization (DESI).

The above technologies mainly are applicable to atmospheric pressure ionization source. However, the atmospheric pressure environment itself limits the diameter of the vacuum system interface of the mass spectrometer, thus causing a great limitation to the improvement of ion transfer efficiency.

U.S. Pat. No. 8,173,960 adopts an electrospray ionization source below atmospheric pressure. However, the outlet of the electrospray ionization source chamber at a pressure below atmospheric pressure is directly connected to the inlet of the chamber of a following-stage ion focusing guide in this technology, causing lots of neutral noises (such as solvent gas molecule) generated during the process of ionization to directly enter the next-stage ion focusing guide, thus reducing the detection signal-to-noise ratio of the instrument and also bringing a great pollution to the ion focusing guide.

### SUMMARY OF THE INVENTION

In view of the drawbacks in the above existing technologies, the present invention aims to provide an ionization and ion introduction device for a mass spectrometer, which transfers an ionization source from an atmospheric pressure environment to an environment below atmospheric pressure, to further enlarge the diameter of the vacuum system interface of the mass spectrometer and improve the transfer efficiency of ions, and which has at least one transfer chamber at pressure below atmospheric pressure arranged between the ionization source chamber and an ion focusing guide chamber, to further improve the detection sensitivity of the mass spectrometer.

To achieve the above aim and other relevant aims, the present invention provides an ionization and ion introduction device for a mass spectrometer, including: an ionization source chamber at a pressure below atmospheric pressure; at least one ionization source, which is arranged in the ionization source chamber to generate ions; at least one ion focusing guide chamber, which is arranged to guide ions into a mass analysis device chamber connected therewith; at least one transfer chamber at pressure below atmospheric pressure, which is located between the ionization source chamber and the ion focusing guide chamber, including an inlet interconnected to the ionization source chamber and an outlet interconnected to the ion focusing guide chamber, wherein the pressure of the transfer chamber is lower than that of the ionization source chamber but higher than that of the ion focusing guide chamber.

According to the above ionization and ion introduction device for mass spectrometer, the transfer chamber further includes at least one vacuum pump suction port for connecting to a vacuum pump.

According to the above ionization and ion introduction device for mass spectrometer, the ionization source includes one of an electrospray ion source, a glow discharge ion source, a dielectric barrier discharge ion source, a chemical an ionization ion source, a desorption corona beam ion source, a laser desorption ion source and a photo-ionization ion source, or combinations thereof.

According to the above ionization and ion introduction device for mass spectrometer, the pressure below atmospheric pressure is from 0.0001 to 1 Torr, from 1 to 50 Torr, from 50 to 300 Torr, and from 300 to 700 Torr.

According to the above ionization and ion introduction device for mass spectrometer, the inlet of the transfer chamber interconnected to the ionization source chamber and the outlet of the transfer chamber interconnected to the ion focusing guide chamber are one of a circular hole, a capillary, a taper hole, a nozzle hole, a reducing hole and a scaling hole, or combinations thereof.

According to the above ionization and ion introduction device for mass spectrometer, a direct voltage is applied to the inlet and outlet.

According to the above ionization and ion introduction device for mass spectrometer, the ionization source is used in combination with liquid chromatography.

According to the above ionization and ion introduction device for mass spectrometer, the ion focusing guide chamber has an ion focusing guide arranged therein and includes at least one vacuum pump suction port.

Further, according to the above ionization and ion introduction device for mass spectrometer, the ion focusing guide is one of an ion funnel, a multipole rod ion guide, a Q-array ion guide and a travelling wave ion guide, or combinations thereof.

Further, according to the above ionization and ion introduction device for mass spectrometer, the mass analysis device chamber has a mass detector and a mass analyzer arranged therein and includes at least one vacuum pump suction port, wherein the mass analyzer includes one of a single-quadrupole mass spectrometer device, a multi-quadrupole mass spectrometer device, a time of flight mass spectrometer device, a multi-quadrupole time of flight mass spectrometer device, a Fourier transform ion cyclotron resonance mass spectrometer device and an ion trap spectrometer device, or combinations thereof, and the mass detector is arranged to obtain a signal of ions impacted thereon or a signal of an ion current moving in the mass analyzer.

According to the above ionization and ion introduction device for mass spectrometer, the included angle between the central axes of the ionization source and the inlet of the transfer chamber interconnected to the ionization source chamber is from 0 to 90 degrees.

According to the above ionization and ion introduction device for mass spectrometer, the included angle between the central axis of the inlet of the transfer chamber interconnected to the ionization source chamber and the central axis of the outlet of the transfer chamber interconnected to the ion focusing guide chamber is from 0 to 90 degrees.

According to the above ionization and ion introduction device for mass spectrometer, the ionization source serves as a secondary ionization source for direct sample analysis.

According to the above ionization and ion introduction device for mass spectrometer, the ionization source is applied to one of a single-quadrupole mass spectrometer, a multi-quadrupole mass spectrometer, a time of flight mass spectrometer, a multi-quadrupole time of flight mass spectrometer, a Fourier transform ion cyclotron resonance mass spectrometer and anion trap spectrometer.

According to the above ionization and ion introduction device for mass spectrometer, a porous channel is arranged between the inlet of the transfer chamber interconnected to the ionization source and the outlet of the transfer chamber interconnected to the ion focusing guide chamber.

According to the above ionization and ion introduction device for mass spectrometer, at least one electrode, to which a direct voltage and a radio-frequency voltage are applied, is arranged between the inlet of the transfer chamber interconnected to the ionization source and the outlet of the transfer chamber interconnected to the ion focusing guide chamber.

As described above, the ionization and ion introduction device for mass spectrometer provided in the present invention includes at least one ionization source located in an environment below atmospheric pressure, an ionization source chamber at a pressure below atmospheric pressure, and at least one transfer chamber at pressure below atmospheric pressure. The transfer chamber is located between the ionization source chamber and the ion focusing guide chamber, including an inlet only connected to the outlet of the ionization source chamber, an outlet only connected to the inlet of the ion focusing guide chamber, and at least one vacuum pump suction port; the pressure of the transfer chamber is lower than that of the ionization source chamber but higher than that of the ion focusing guide chamber. In particular, first, the transfer chamber is arranged to assist the ionization source chamber to realize an environment below atmospheric pressure, in which discharge current is increased or photon flight distance is increased, so that the ionization efficiency of the ionization source is greatly improved; as for the electrospray ionization source, the environment below atmospheric pressure greatly reduces the repulsion between charged droplets, making the electrospray narrower, thereby increasing the number of charged droplets per unit volume, increasing the number of charged droplets entering the next-stage vacuum chamber and improving detection efficiency. At the same time, the ionization source in the environment below atmospheric pressure can make an enlarged diameter for the inlet of the next-stage transfer chamber at pressure below atmospheric pressure interconnected to the ionization source chamber, thereby improving the transfer efficiency of charged droplets and ions; pumping the transfer chamber at pressure below atmospheric pressure through a vacuum pump can reduce the gas pressure in the ionization source chamber, without directly interfering the ionization source. Second, the transfer chamber can separate charged droplets or ions from other solvents and impurity molecules using the pressure difference between the ionization source chamber and the ion focusing guide chamber, through the special design of interface between chambers, the vacuum pumping of the transfer chamber and the aerodynamic transfer principle. Smaller neutral solvent gas molecules and other small impurity gas molecules are easily exhausted by the vacuum pump due to low mass and low inertia, while charged droplets and analyte molecules still keep forward movement due to large mass and large inertia and enter the next-stage ion focusing guide through the outlet of the transfer chamber at pressure below atmospheric pressure; therefore, the transfer chamber below atmospheric pressure can further remove solvents and impurities in the environment, thereby reducing the limit of detection of the mass spectrometer; the addition of at least one stage of vacuum chamber also can reduce the load of the vacuum pump of the final-stage vacuum chamber and facilitate the desolvation of analyte, thereby improving the detection sensitivity of the mass spectrometer.

### BRIEF DESCRIPTION OF THE DRAWINGS

FIG. 1 shows a structure diagram of an embodiment of an ionization and ion introduction device for mass spectrometer according to the present invention.

FIG. 2 shows a structure diagram of an embodiment of an ionization and ion introduction device for mass spectrometer according to the present invention.

FIG. 3 shows a structure diagram of an embodiment of an ionization and ion introduction device for mass spectrometer according to the present invention.

FIG. 4 shows a structure diagram of an embodiment of an ionization and ion introduction device for mass spectrometer according to the present invention.

FIG. 5 shows a structure diagram of an embodiment of an ionization and ion introduction device for mass spectrometer according to the present invention.

FIG. 6 shows a structure diagram of an embodiment of an ionization and ion introduction device for mass spectrometer according to the present invention.

FIG. 7 shows a structure diagram of an embodiment of an ionization and ion introduction device for mass spectrometer according to the present invention.

FIG. 8 shows a structure diagram of an embodiment of an ionization and ion introduction device for mass spectrometer according to the present invention.

Description of designators is as follows:
1, 1a, 1b, 1c, 1d, 1e, 1f, 1g: ionization source;
2, 2a, 2b, 2c, 2d, 2e, 2f, 2g: ionization source chamber;
3, 3a, 3b, 3c, 3d, 3e, 3f, 3g: inlet of transfer chamber interconnected to ionization source chamber;
4, 4a, 4b, 4c, 4d, 4e, 4f, 4g: outlet of transfer chamber interconnected to ion focusing guide chamber;
5, 5a, 5b, 5c, 5d, 5e, 5f, 5g: transfer chamber;
6, 6a, 6b, 6c, 6d, 6e, 6f, 6g: ion focusing guide;
7, 7a, 7b, 7c, 7d, 7e, 7f, 7g: ion focusing guide chamber;
8, 8a, 8b, 8c, 8d, 8e, 8f, 8g: mass analysis device chamber;
9, 9a, 9b, 9c, 9d, 9e, 9f, 9g: vacuum pump suction port of transfer chamber;
10, 10a, 10b, 10c, 10d, 10e, 10f, 10g: vacuum pump suction port of ion focusing guide chamber
11, 11a, 11b, 11c, 11d, 11e, 11f, 11g: vacuum pump suction port of mass analysis device chamber;
12d: second transfer chamber;
13d: interface opening between first transfer chamber and second transfer chamber;
14e: porous channel;
15f: electrode,

### DETAILED DESCRIPTION OF THE INVENTION

Embodiments of the present invention are described below through specific examples. Those skilled in the art may easily learn other advantages and functions of the present invention from the content disclosed in the specification. The present invention also may be implemented or applied through other different embodiments, and what details described in the present invention may be modified or changed based on different views and applications without departing from the spirit of the present invention.

It should be noted that the drawings provided in embodiments are simply to illustrate the basic idea of the present invention in a schematic way, only showing components relevant to the present invention but drawn according to the number, shape and dimension of the components during actual implementation. During actual implementation, the shape, number and proportion of each component may be changed randomly and the layout of components might be more complex.

### Embodiment 1

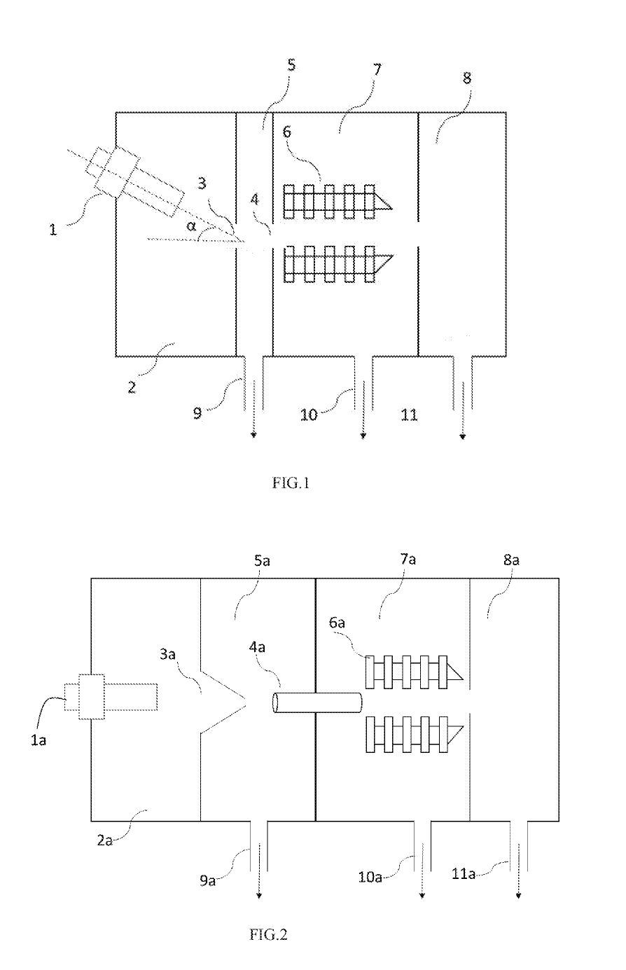

Please refer to FIG. 1, the present invention provides an ionization and ion introduction device for a mass spectrometer, including: an ionization source chamber 2 below atmospheric pressure; at least one ionization source 1, which is arranged in the ionization source chamber 2 to generate ions; at least one transfer chamber 5 below atmospheric pressure, which is arranged to transfer generated ions to an ion focusing guide chamber 7. The ion focusing guide chamber 7 is arranged to guide ions into a mass analysis device chamber 8 connected therewith. The transfer chamber 5 is located between the ionization source chamber 2 and the ion focusing guide chamber 7, including an inlet 3 interconnected to the ionization source chamber 2 and an outlet 4 interconnected to the ion focusing guide chamber 7, and at least one vacuum pump suction port 9. The pressure in the transfer chamber 5 is lower than that in the ionization source chamber 2 but higher than that in the ion focusing guide chamber 7. The transfer chamber 5 is arranged to assist the ionization source chamber 2 to realize an environment below atmospheric pressure. At the same time, the transfer chamber 5 separates charged droplets, ions and other solvents and impurity molecules by using the aerodynamic transfer principle. The transfer chamber 5 is connected to a vacuum pump through a vacuum pump suction port 9, so as to reduce the pressure in the ionization source chamber 2, without directly interfering the ionization source 1, and to remove solvents and impurities in the environment, thereby reducing the detection noise of the mass spectrometer and increasing the number of analyte ions entering the ion focusing guide chamber 7. The addition of at least one stage of transfer chamber 5 also can reduce the load of the vacuum pump of the final-stage transfer chamber.

In one aspect, the ionization source 1 located in an environment below atmospheric pressure includes one of an electrospray ion source, a glow discharge ion source, a dielectric barrier discharge ion source, a chemical ionization ion source, a desorption corona beam ion source, a laser desorption ion source and a photo-ionization ion source, or combinations thereof. Since, in the environment below atmospheric pressure, charge repulsion is reduced, discharge current is increased and photon flight distance is increased, the ionization efficiency and transfer efficiency of the electrospray ion source, the glow discharge ion source and the photo-ionization ion source are greatly improved, which makes the electrospray ion source, the glow discharge ion source and the photo-ionization ion source optimal schemes for low-pressure ionization source.

In one aspect, the ionization source located in an environment below atmospheric pressure may serve as a secondary ionization source for direct sample analysis.

In one aspect, the ionization source may be applied to one of a single-quadrupole mass spectrometer, a multi-quadrupole mass spectrometer, a time of flight mass spectrometer, a multi-quadrupole time of flight mass spectrometer, a Fourier transform ion cyclotron resonance mass spectrometer and anion trap spectrometer.

In one aspect, the pressure below atmospheric pressure can be from 0.0001 to 1 Torr, from 1 to 50 Torr, from 50 to 300 Torr, or from 300 to 700 Torr. Preferably, the pressure corresponding to the electrospray ion source below atmospheric pressure is 1 to 300 Torr, the pressure corresponding to the glow discharge ion source below atmospheric pressure is 0.0001 to 300 Torr, and the pressure corresponding to the photo-ionization ion source below atmospheric pressure is 0.0001 to 300 Torr.

In one aspect, the inlet 3 of the transfer chamber 5 interconnected to the ionization source chamber 2 and the outlet 4 of the transfer chamber 5 interconnected to the ion focusing guide chamber 7 are one of a circular hole, a capillary, a taper hole, a nozzle hole, a reducing hole and a scaling hole, or combinations thereof, to which certain direct voltage can be applied.

In one aspect, the ionization source 1 is used in combination with liquid chromatography.

In one aspect, the ion focusing guide chamber 7 has an ion focusing guide 6 arranged therein and includes at least one vacuum pump suction port 10. The ion focusing guide 6 is one of an ion funnel, a multipole rod ion guide, a Q-array ion guide and a travelling wave ion guide, or combinations thereof.

In one aspect, the other side of the ion focusing guide chamber 7 is provided with a mass analysis device chamber 8, which may have a mass detector and a mass analyzer arranged therein and include at least one vacuum pump suction port 11. The mass analyzer, for example, is one of a single-quadrupole mass spectrometer device, a multi-quadrupole mass spectrometer device, a time of flight mass spectrometer device, a multi-quadrupole time of flight mass spectrometer device, a Fourier transform ion cyclotron resonance mass spectrometer device and an ion trap spectrometer device, or combinations thereof; and the mass detector is a device configured to obtain a signal of ions impacted thereon or a signal of an ion current moving in the mass analyzer.

In this embodiment, the included angle between the central axes of the ionization source 1 and the inlet 3 of the transfer chamber 5 interconnected to the ionization source chamber 2 is from 0 to 90 degrees (that is, the included angle α shown in FIG. 1), for being applicable to the electrospray ionization source and other desorption ionization sources with different sample flow rates.

In addition, the included angle between the central axis of the inlet 3 of the transfer chamber 5 interconnected to the ionization source chamber 2 and the central axis of the outlet 4 of the transfer chamber 5 interconnected to the ion focusing guide chamber 7 is from 0 to 90 degrees.

### Embodiment 2

The ionization and ion introduction device for mass spectrometer may take many forms. As shown in FIG. 2, the ionization source 1a is an electrospray ionization source, which is leveled with the transfer chamber 5a below atmospheric pressure, that is, the included angle α between the central axes of the ionization source 1a and the inlet 3a of the transfer chamber 5a interconnected to the ionization source chamber 2a is 0. The inlet 3a of the transfer chamber 5a interconnected to the ionization source chamber 2a is a reducing hole, which can well collect the ions or charged droplets generated by the ionization source 1a using the aerodynamic principle and transfer them to the transfer chamber 5a below atmospheric pressure. In the transfer chamber 5a below atmospheric pressure, the charged droplets transferred thereto can be separated from neutral solvent gas through a vacuum pump suction port 9a, so as to reduce neutral noises and improve the signal-to-noise ratio of the instrument. The outlet 4a of the transfer chamber 5a interconnected to the ion focusing guide chamber 7a is a metallic capillary, which further facilitates the desolvation of charged droplets by a heating manner, thereby improving the signal-to-noise ratio of the instrument.

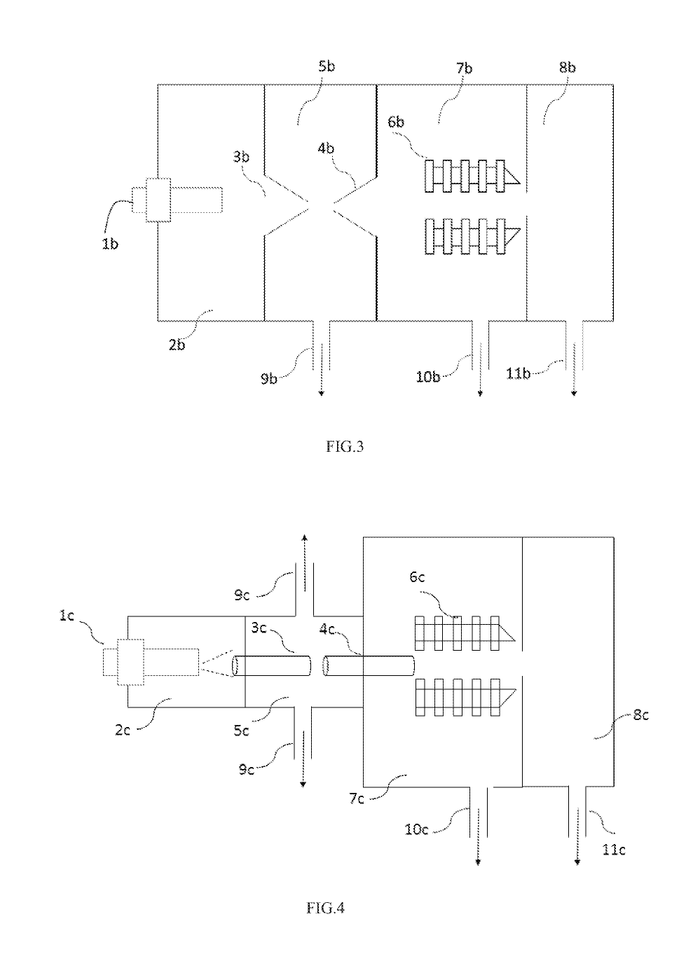

As shown in FIG. 3, a taper hole is adopted for the outlet 4b of the transfer chamber 5b interconnected to the ion focusing guide chamber 7b, which can improve the transmittance of ions and block large droplets and other neutral noises, also beneficial for the improvement of sensitivity and signal-to-noise ratio of the instrument.

As shown in FIG. 4, the inlet 3c of the transfer chamber 5c below atmospheric pressure is a metallic capillary and the outlet 4c of the transfer chamber 5c below atmospheric pressure interconnected to the chamber 7c of the ion focusing guide 6c is a metallic capillary too, both of which prolong the traveling distance of charged droplets before entering the mass spectrometer, thereby facilitating the desolvation. Meanwhile, both two metallic capillaries may further facilitate the desolvation of charged droplets by a heating manner.

### Embodiment 3

As shown in FIG. 5, different from the above embodiments shown in FIG. 2 to FIG. 4, the ionization and ion introduction device for mass spectrometer includes a plurality of transfer chambers 5d and 12d below atmospheric pressure in this embodiment, which can further remove neutral noises and meanwhile can enlarge the inlet 3d of the first transfer chamber 5d below atmospheric pressure interconnected to the ionization source 1d so as to improve the transmittance of charged droplets or ions. In particular, the gas pressure of the first transfer chamber 5d below atmospheric pressure is higher than that of the second transfer chamber 12d below atmospheric pressure, while the gas pressure of the second transfer chamber 12d below atmospheric pressure is higher than that of the ion focusing guide chamber 7d. Multiple stages of transfer chambers below atmospheric pressure also may help reduce the vacuum pump load of following stages of vacuum systems of the mass spectrometer.

Preferably, the inlet 3d of the first transfer chamber 5d below atmospheric pressure interconnected to the ionization source 1d, the outlet 4d of the second transfer chamber 12d below atmospheric pressure interconnected to the ion focusing guide chamber 7d, the interface opening 13d between the first transfer chamber 5d below atmospheric pressure and the second transfer chamber 12d below atmospheric pressure adopt one of a circular hole, a capillary, a taper hole, a nozzle hole, a reducing hole and a scaling hole, or combinations thereof.

To be further applicable to different applications, two embodiments are provided below.

### Embodiment 4

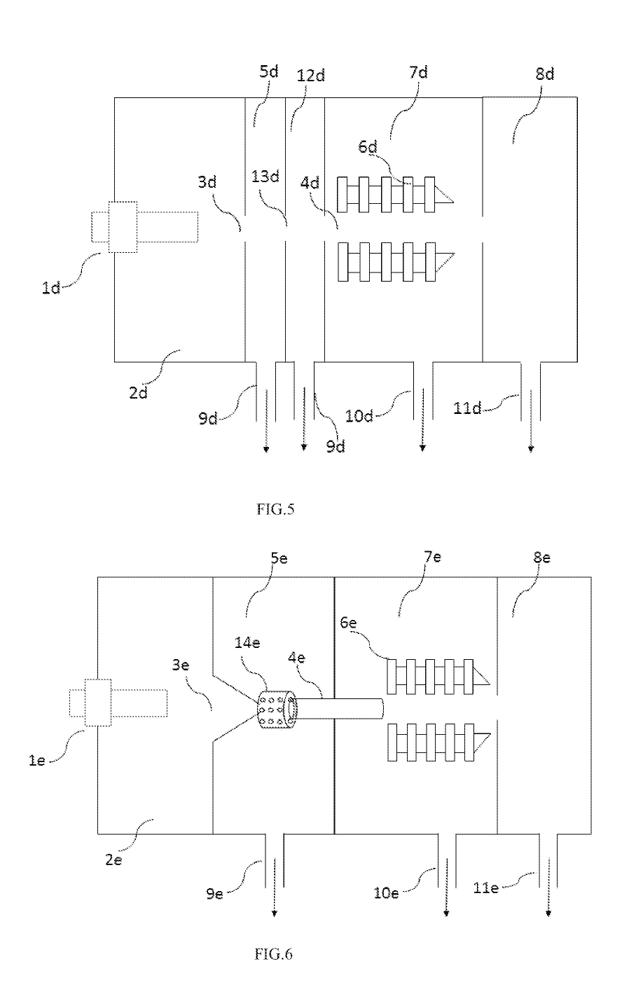

As shown in FIG. 6, different from the above embodiments shown in FIG. 2 to FIG. 5, a porous channel 14e is arranged between the inlet 3e of the transfer chamber 5e interconnected to the ionization source 1e and the outlet 4e of the transfer chamber 5e interconnected to the ion focusing guide chamber 7e in this embodiment. The porous channel 14e may facilitate charged droplets and ions to be focused again after exiting the inlet 3e, and to enter the ion focusing guide 6e through the outlet 4e, so as to further improve the transfer efficiency of ions. At the same time, the porous structure does not increase the flow resistance of the air flow generated by the vacuum pump suction port 9e of the transfer chamber 5e below atmospheric pressure, thereby achieving the effect of neutral noise removal.

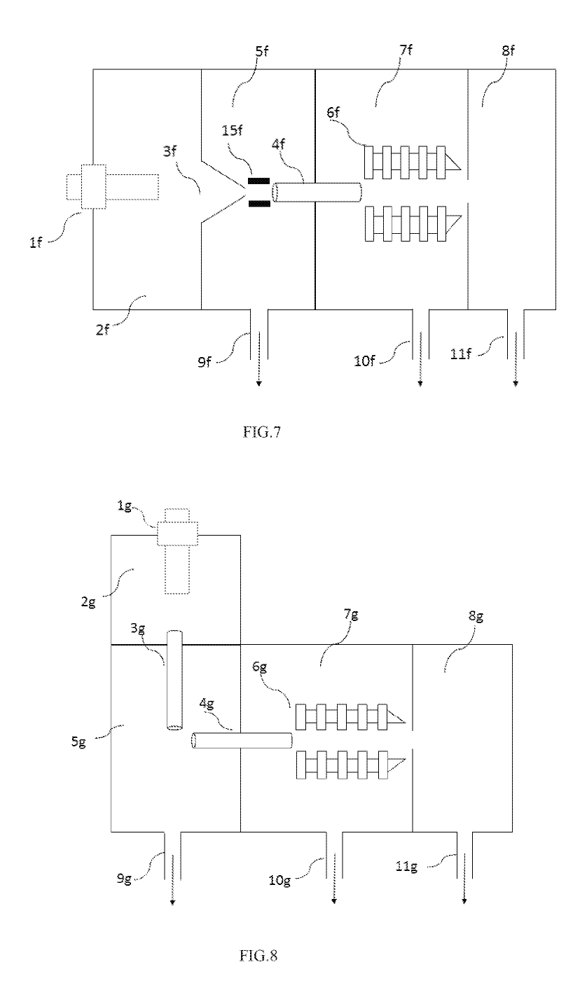

The porous channel 14e also can be replaced by an electrode, as shown in FIG. 7. At least one electrode 15f is arranged between the inlet 3f of the transfer chamber 5f interconnected to the ionization source 1f and the outlet 4f of the transfer chamber 5f interconnected to the ion focusing guide chamber 7f. Certain direct voltage and radio-frequency voltage may be applied to the electrode 15f, thereby accelerating the focusing of the charged droplets and ions entering the transfer chamber 5f below atmospheric pressure from the inlet 3f and improving the corresponding ion transfer efficiency.

### Embodiment 5

As shown in FIG. 8, different from the above embodiments, the included angle between the central axis of the inlet 3g of the transfer chamber 5g interconnected to the ionization source 1g and the central axis of the outlet 4g of the transfer chamber 5g interconnected to the chamber 7g of the ion focusing guide 6g is 90 degrees in this embodiment. In particular, the inlet 3g of the transfer chamber 5g interconnected to the ionization source 1g and the outlet 4g of the transfer chamber 5g interconnected to the ion focusing guide chamber 7g is one of a circular hole, a capillary, a taper hole, a nozzle hole, a reducing hole and a scaling hole, or combinations thereof. Ions with large mass entering from the inlet 3g are exhausted out through a vacuum pump by the inertia effect, while ions with low mass are guided to the ion focusing guide 6g through the outlet 4g by the air flow generated by the pressure difference between the transfer chamber 5g and the chamber 7g of the ion focusing guide 6g. Therefore, this device may be employed for the separation of complex samples; it can reserve analyte ions with low mass and remove impurity ions with large mass, thereby reducing the impact on analyte detection by impurities.

To sum up, the ionization and ion introduction device for mass spectrometer provided in the present invention includes at least one ionization source located in an environment below atmospheric pressure, an ionization source chamber at a pressure below atmospheric pressure, and at least one transfer chamber at pressure below atmospheric pressure. The transfer chamber is located between the ionization source chamber and the ion focusing guide chamber, including an inlet only connected to the outlet of the ionization source chamber, an outlet only connected to the inlet of the ion focusing guide chamber, and at least one vacuum pump suction port; the pressure of the transfer chamber is lower than that of the ionization source chamber but higher than that of the ion focusing guide chamber. In particular, first, the transfer chamber is arranged to assist the ionization source chamber to realize an environment below atmospheric pressure, in which discharge current is increased or photon flight distance is increased, so that the ionization efficiency of the ionization source is greatly improved; as for the electrospray ionization source, the environment below atmospheric pressure greatly reduces the repulsion between charged droplets, making the electrospray narrower, thereby increasing the number of charged droplets per unit volume, increasing the number of charged droplets entering the next-stage vacuum chamber and improving detection efficiency. At the same time, the ionization source in the environment below atmospheric pressure can make an enlarged diameter for the inlet of the next-stage transfer chamber at pressure below atmospheric pressure interconnected to the ionization source chamber, thereby improving the transfer efficiency of charged droplets and ions; pumping the transfer chamber at pressure below atmospheric pressure through a vacuum pump can reduce the gas pressure in the ionization source chamber, without directly interfering the ionization source. Second, the transfer chamber can separate charged droplets or ions from other solvents and impurity molecules using the pressure difference between the ionization source chamber and the ion focusing guide chamber, through the special design of interface between chambers, the vacuum pumping of the transfer chamber and the aerodynamic transfer principle. Smaller neutral solvent gas molecules and other small impurity gas molecules are easily exhausted by the vacuum pump due to low mass and low inertia, while charged droplets and analyte molecules still keep forward movement due to large mass and large inertia and enter the next-stage ion focusing guide through the outlet of the transfer chamber at pressure below atmospheric pressure; therefore, the transfer chamber at pressure below atmospheric pressure can further remove solvents and impurities in the environment, thereby reducing the limit of detection of the mass spectrometer; the addition of at least one stage of vacuum chamber also can reduce the load of the vacuum pump of the final-stage vacuum chamber and facilitate the desolvation of analyte, thereby improving the detection sensitivity of the mass spectrometer.

The above embodiments illustrate the principle and functions of the present invention through examples simply and are not intended to limit the present invention. Those familiar with the technology may make modifications or changes to the above embodiments without departing from the spirit and scope of the present invention. Thus, all modifications or changes accomplished by the ordinary staff in this technical field without departing from the spirit and technical idea disclosed in the present invention are intended to be covered by the claims appended below.

What is claimed is:

1. An ionization and ion introduction device for mass spectrometer, comprising:
an ionization source chamber at a pressure below atmospheric pressure;
at least one ionization source, which is arranged in the ionization source chamber to generate ions;
at least one ion focusing guide chamber, which is arranged to guide ions into a mass analysis device chamber connected to the ion focusing device chamber;
at least one transfer chamber at pressure below atmospheric pressure, which is located between the ionization source chamber and the ion focusing guide chamber, comprising an inlet from the ionization source chamber to the transfer chamber and an outlet from the transfer chamber to the ion focusing guide chamber, wherein
the pressure of the transfer chamber is lower than the pressure of the ionization source chamber but higher than the pressure of the ion focusing guide chamber.

2. The ionization and ion introduction device for mass spectrometer according to claim 1, wherein the transfer chamber further comprises at least one vacuum pump suction port for connecting to a vacuum pump.

3. The ionization and ion introduction device for mass spectrometer according to claim 1, wherein the ionization source comprises one of an electrospray ion source, a glow discharge ion source, a dielectric barrier discharge ion source, a chemical ionization ion source, a desorption corona beam ion source, a laser desorption ion source and a photo-ionization ion source, or combinations thereof.

4. The ionization and ion introduction device for mass spectrometer according to claim 1, wherein the air pressure below atmospheric pressure is from 0.0001 to 1 Torr, from 1 to 50 Torr, from 50 to 300 Torr, or from 300 to 700 Torr.

5. The ionization and ion introduction device for mass spectrometer according to claim 1, wherein the inlet from the ionization source chamber to the transfer chamber and the outlet from the transfer chamber to the ion focusing guide chamber are one of a circular hole, a capillary, a tapered hole, a nozzle hole, a reducing hole and a scaling hole, or combinations thereof.

6. The ionization and ion introduction device for mass spectrometer according to claim 1, wherein a direct voltage is applied to the inlet and outlet.

7. The ionization and ion introduction device for mass spectrometer according to claim 1, wherein the ionization source is used in combination with liquid chromatography.

8. The ionization and ion introduction device for mass spectrometer according to claim 1, wherein the ion focusing guide chamber has an ion focusing guide arranged therein and comprises at least one vacuum pump suction port.

9. The ionization and ion introduction device for mass spectrometer according to claim 1, wherein the ion focusing guide is one of an ion funnel, a multipole rod ion guide, a Q-array ion guide and a travelling wave ion guide, or combinations thereof.

10. The ionization and ion introduction device for mass spectrometer according to claim 1, wherein the mass analysis device chamber has a mass detector and a mass analyzer arranged therein and comprises at least one vacuum pump suction port, the mass analyzer comprises one of a single-quadrupole mass spectrometer device, a multi-quadrupole mass spectrometer device, a time of flight mass spectrometer device, a multi-quadrupole time of flight mass spectrometer device, a Fourier transform ion cyclotron resonance mass spectrometer device and an ion trap spectrometer device, or combinations thereof, and the mass detector is arranged to obtain a signal of ions impacted thereon or a signal of anion current moving in the mass analyzer.

11. The ionization and ion introduction device for mass spectrometer according to claim 1, wherein an included angle between central axes of the ionization source and the inlet from the ionization source chamber to the transfer chamber is from 0 to 90 degrees.

12. The ionization and ion introduction device for mass spectrometer according to claim 1, wherein an included angle between the central axis of the inlet from the ionization source chamber to the transfer chamber and the central axis of the outlet from the transfer chamber to the ion focusing guide chamber is from 0 to 90 degrees.

13. The ionization and ion introduction device for mass spectrometer according to claim 1, wherein the ionization source serves as a secondary ionization source for direct sample analysis.

14. The ionization and ion introduction device for mass spectrometer according to claim 1, wherein the ionization source is applied to one of a single-quadrupole mass spectrometer, a multi-quadrupole mass spectrometer, a time of flight mass spectrometer, a multi-quadrupole time of flight mass spectrometer, a Fourier transform ion cyclotron resonance mass spectrometer and an ion trap spectrometer.

15. The ionization and ion introduction device for mass spectrometer according to claim 1, wherein a porous channel is further arranged between the inlet from the ionization source to the transfer chamber and the outlet from the transfer chamber to the ion focusing guide chamber.

16. The ionization and ion introduction device for mass spectrometer according to claim 1, wherein at least one electrode, to which a direct voltage and a radio-frequency voltage are applied, is further arranged between the inlet from the ionization source to the transfer chamber and the outlet from the transfer chamber to the ion focusing guide chamber.
